(19) United States
(12) Patent Application Publication
(10) Pub. No.: US 2026/0187400 A1
(43) Pub. Date: Jul. 2, 2026

(54) VICINITY USE CARD

(71) Applicant: Visa International Service Association, San Francisco, CA (US)

(72) Inventors: Yuexi CHEN, Foster City, CA (US); Gregory MILLER, Stamford, CT (US)

(73) Assignee: Visa International Service Association, San Francisco, CA (US)

(21) Appl. No.: 19/131,425

(22) PCT Filed: Dec. 11, 2022
(86) PCT No.: PCT/US2022/081331

§ 371 Date: May 20, 2025

(51) Int. Cl. G06K 19/07; G06Q 20/42

(52) U.S. Cl. CPC G06K 19/0704; G06Q 20/42

(57) ABSTRACT

The present disclosure provides various cards (e.g., payment cards, identification cards, driver's license cards) that are removably attachable to a portable electronic device. In some aspects, the portable electronic device is configured for reverse wireless charging and includes a device charging coil. The card includes a card charging coil, a capacitor electrically coupled to the card charging coil, and a circuit. The card charging coil can produce a current from magnetic flux generated by the device charging coil. The circuit can cause the capacitor to charge when the card is attached to the portable electronic device and cause the capacitor to discharge upon removal of the card from the portable electronic device.

### TECHNICAL FIELD

At least some aspects of the present disclosure relate to cards (e.g., payment cards, identification cards, driver's license cards, access cards, etc.), such as cards that are removably attachable to a portable electronic device and cards that implement a security action based on their removal from the portable electronic device.

### BACKGROUND

Fraudsters often attempt to use lost or stolen payment cards to complete fraudulent transactions. Moreover, with the introduction of features like Quick Chip and Tap to Pay, fraudsters are sometimes able to steal payment cards and conduct small transactions using the stolen cards without needing to perform cardholder verification.

Accordingly, there is a need for devices, systems, and methods to prevent fraudsters from conducting fraudulent transactions using lost and/or stolen payment cards. The present disclosure provides solutions utilizing vicinity use cards. In some aspects, the vicinity use cards can be cards that are removably attachable to a portable electronic device and implement a security action based on their removal from the portable electronic device.

### SUMMARY

According to one aspect, the present disclosure provides a card removably attachable to a portable electronic device. The portable electronic device can be configured for reverse wireless charging and can include a device charging coil. The card can include a card charging coil, a capacitor, and a circuit. The card charging coil can produce a current from magnetic flux generated by the device charging coil. The capacitor can be electrically coupled to the card charging coil. The circuit can be configured to cause the capacitor to charge when the card is attached to the portable electronic device and cause the capacitor to discharge upon removal of the card from the portable electronic device.

According to another aspect, the present disclosure provides a payment card. The payment card can include a substrate, an integrated circuit, a card charging coil, and a capacitor. The integrated circuit can be supported by the substrate and can be configured to communicate with an access device to determine whether to complete a transaction. The card charging coil can be supported by the substrate and can produce a current from a magnetic flux generated by a wireless charging device. The capacitor can be supported by the substrate and can be electrically coupled to the card charging coil. Further, the capacitor can be charged with the current produced by the card charging coil.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, together with the detailed description below, are incorporated in and form part of the specification, and serve to further illustrate aspects of concepts that include the claimed disclosure and explain various principles and advantages of those aspects.

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIGS. 1A-1B are perspective views illustrating a vicinity use card that is removably attachable to a portable electronic device, according to at least one aspect of the present disclosure.

FIG. 2 illustrates a simplified representation of a wireless charging system incorporating ferromagnetic components disposed about respective charging coils, according to at least one aspect of the present disclosure.

FIG. 3 illustrates a portable electronic device including various components of a wireless charging system configured for reverse wireless charging, according to at least one aspect of the present disclosure.

FIG. 4 illustrates a vicinity use card, according to at least one aspect of the present disclosure.

FIG. 5 illustrates a vicinity use card removably attaching to a portable electronic, according to at least one aspect of the present disclosure.

FIGS. 6A-6B illustrate a vicinity use card aligning relative to a portable electronic device using an alignment magnet, according to at least one aspect of the present disclosure.

FIG. 7 illustrates a simplified block circuit diagram of a vicinity use card and a portable electronic device, according to at least one aspect of the present disclosure.

FIG. 8 is a graph illustrating the relationship between capacitor discharge level and discharge time for a given charged voltage, resistance, and capacitance, according to at least one aspect of the present disclosure.

FIG. 9 illustrates an example authentication protocol that may be implemented by a vicinity use card and/or a portable electronic device, according to at least one aspect of the present disclosure.

FIGS. 10A-10D illustrate vicinity use cards with various magnet arrays, according to several aspects of the present disclosure.

FIG. 11A-11B illustrate exploded views of various vicinity use cards including multiple layers, according to several aspects of the present disclosure.

FIG. 12A-12C illustrate cross-sectional views of various magnet embedding configurations, according to several aspects of the present disclosure.

FIG. 13 illustrates a payment network environment, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Before explaining various forms of the vicinity use card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

An “access device” may refer to a device that receives information from a card to initiate a transaction. For example, an access device may be a point-of-sale device configured to read account data encoded in a magnetic stripe or chip of a payment card. Other examples of access devices include cellular phones, personal computers, tablets, handheld specialized readers, set-top boxes, electronic cash registers, automated teller machines (ATMs), virtual cash registers, kiosks, security systems, access systems, and the like. Access devices may use means to interact with a card, such as NFC, radio frequency (RF), optical readers, and/or magnetic stripe readers.

“Account credentials” may include any information that identifies an account and allows a payment processor to verify that a device, person, or entity has permission to access the account. For example, account credentials may include an account identifier (e.g., a primary account number PAN)), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time.

An “acquirer” may refer to an entity licensed by a transaction service provider and/or approved by a transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

A “card” can refer to a payment card, a security card, an access card, a memory card, a driver license card, a loyalty card, a membership card, an insurance card, a passport card, and/or an identification card, or any other type of card that a user may carry and/or any other type of card that a user may use to conduct a transaction. Any of the various aspects disclosed herein with respect to a payment card can be similarly applied to other types of cards. The vicinity use cards described herein can be any type of card.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. As used herein “issuer system” or “issuer institution system” may refer to one or more systems operated by or operated on behalf of an issuer. For example, an issuer system may refer to a server executing one or more software applications associated with the issuer. In some non-limiting aspects of the present disclosure, an issuer system may include one or more servers (e.g., one or more authorization servers) for authorizing a payment transaction. An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “payment card” can refer to any device that may be used to conduct a transaction, such as a financial transaction. For example, a payment card may be used to provide payment information to a merchant. A payment card can include a substrate such as a paper, metal, or plastic card, and information that is printed, embossed, encoded, and/or otherwise included at or near a surface of the payment card. A payment card can be hand-held and compact so that it can fit into a consumer's wallet and/or pocket (e.g., pocket-sized). A payment card can be a smart card, a debit device (e.g., a debit card), a credit device (e.g., a credit card), a stored value device (e.g., a stored value card or “prepaid” card), a magnetic stripe or chip card. A payment card may operate in a contact and/or contactless mode. For example, a payment card may be an electronic payment device, such as a smart card, a chip card, an integrated circuit card, and/or a near field communications (NFC) card, among others. An electronic payment device may include an embedded integrated circuit and the embedded integrated circuit may include a data storage medium (e.g., volatile and/or non-volatile memory) to store information associated with the electronic payment device, such as an account identifier and/or a name of an account holder. A payment card may interface with an access device such as a point-of-sale device to initiate the transaction.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

The terms “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

As used herein, a “portable electronic device” may refer to any electronic device that is portable and operated by user. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “system” may refer to one or more computing devices or combinations of computing devices (e.g., processors, servers, client devices, software applications, components of such, and/or the like).

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

As described above, fraudsters often attempt to conduct fraudulent transactions using lost and/or stolen payment cards. For example, with the introduction of features like Quick Chip and Tap to Pay, fraudsters are sometimes able to steal credit cards and conduct small transactions (e.g., less than $50 USD) without needing to perform cardholder verification. Accordingly, there is a need for devices, systems, and methods to prevent fraudsters from conducting fraudulent transactions using lost and/or stolen payment cards.

The present disclosure provides various cards (e.g., payment cards, identification cards, access cards, driver's license cards, etc.) that can be removably attached to a portable electronic device. In some aspects, the cards disclosed here can implement a security action based on the cards' removal from the portable electronic device, thereby preventing the cards from being used to conduct a fraudulent transaction.

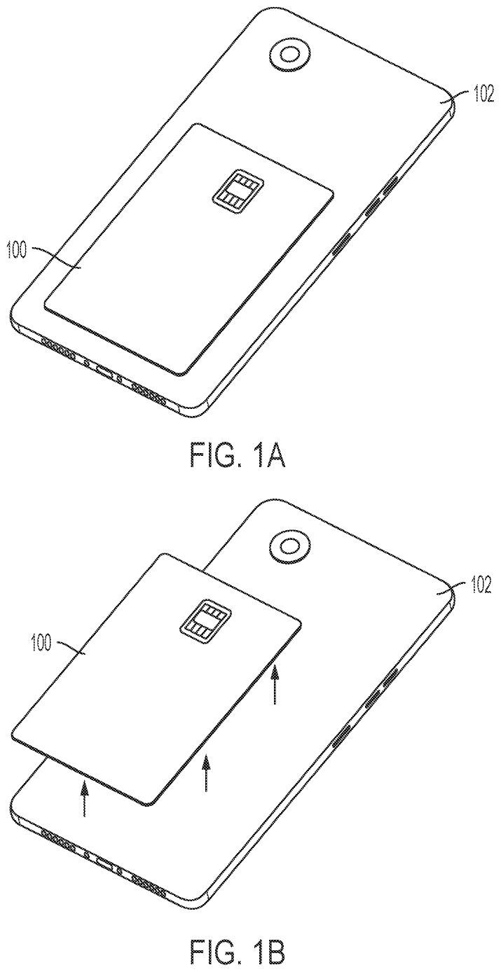

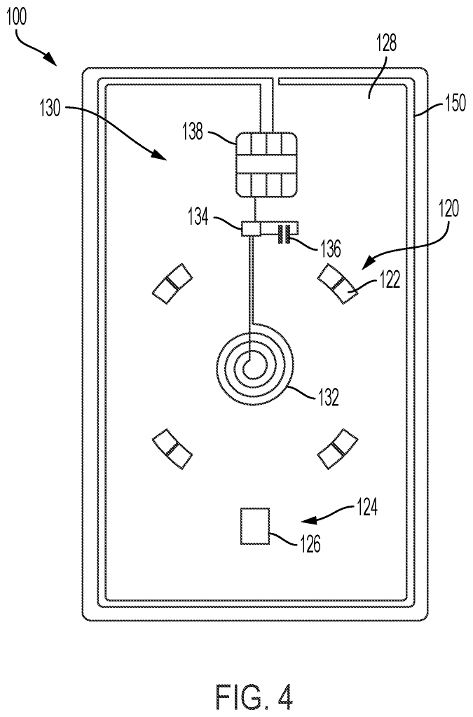

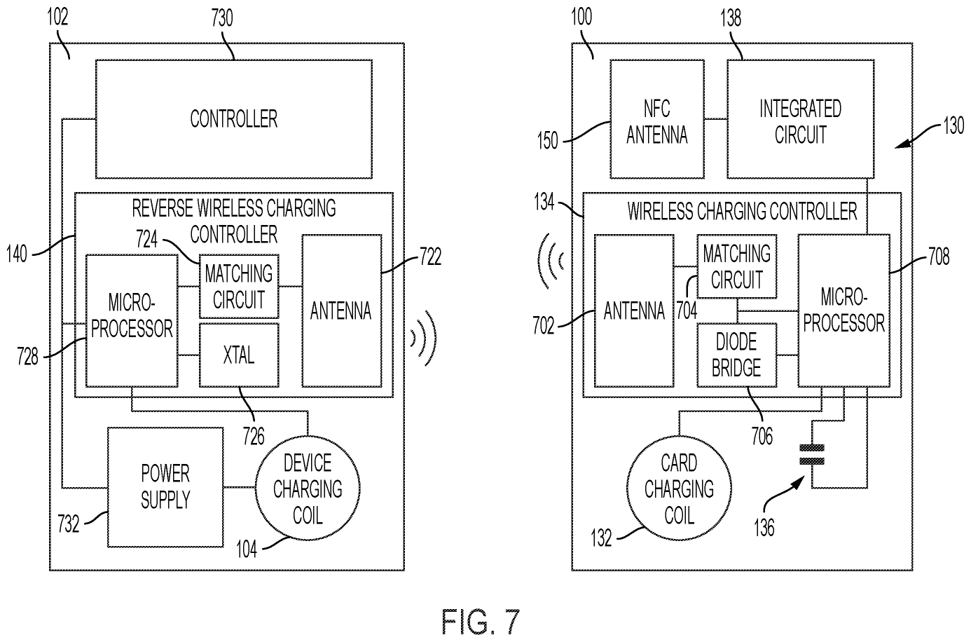

FIGS. 1A-1B are perspective views illustrating a vicinity use card 100 that is removably attachable to a portable electronic device 102, according to at least one aspect of the present disclosure. For example, FIG. 1A illustrates a vicinity use card 100 removably attached to a portable electronic device 102. As described in detail below with respect to FIGS. 4 and 7, the vicinity use card 100 can include a wireless charging coil and a capacitor. When the vicinity use card 100 is attached to the portable electronic device 102, as shown in FIG. 1A, the portable electronic device 102 can induce a current in a wireless charging coil to charge a capacitor.

When the vicinity use card 100 is removed from the portable electronic device 102, as shown in FIG. 1B, a capacitor can begin to discharge. The capacitor can be configured to fully discharge over a predetermined total discharge time and/or at a predetermined discharge rate. Through the discharge of the capacitor, the discharge level of the capacitor can be correlated with a discharge time. Thus, in some aspects, the discharge level of the capacitor can serve as a proxy for determining whether the vicinity use card 100 is within the vicinity of the portable electronic device 102. A security action can be implemented at or after a specific discharge time based on the discharge level of the capacitor reaching a predetermined discharge level threshold. Accordingly, the vicinity use card 100 can implement a security action based on the amount of time that has accumulated since the vicinity use card 100 was removed from the portable electronic device 102. For example, after the vicinity use card 100 has been removed from the portable electronic device 102 for a predetermined period, the vicinity use card 100 may prevent a transaction from being completed. As another example, after the vicinity use card 100 has been removed from the portable electronic device 102 for a predetermined period, the vicinity use card 100 may require cardholder verification prior to allowing a transaction to be completed. Accordingly, a fraudster who may have stolen or found the vicinity use card 100 can be prevented from completing a transaction using the vicinity use card 100.

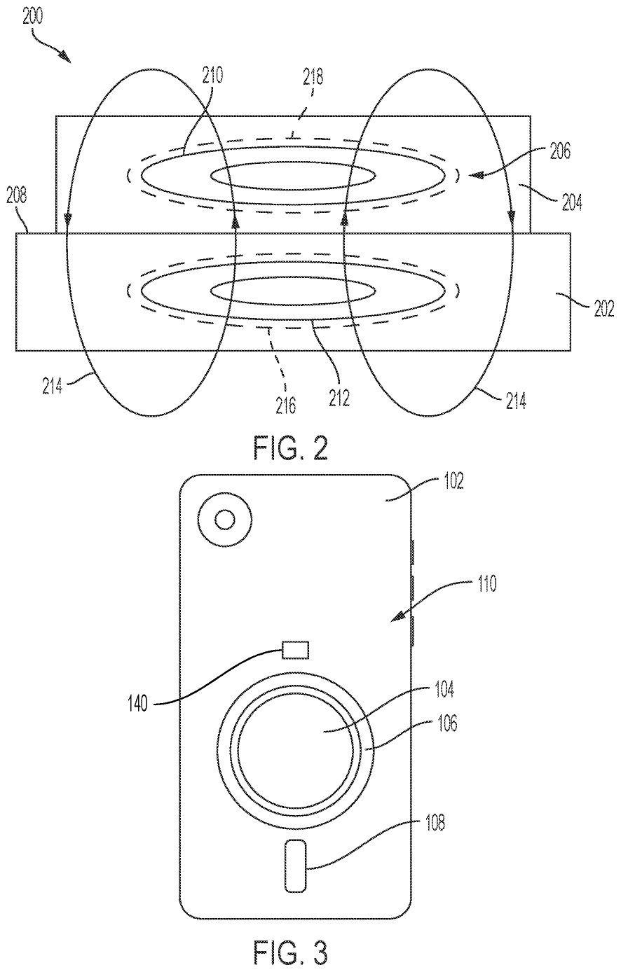

FIGS. 2-3 and the accompanying description below provide examples of wireless charging systems and reverse wireless charging systems in portable electronic devices. Following these examples, the disclosure provides details related to various vicinity use cards.

FIG. 2 illustrates a simplified representation of a wireless charging system 200 incorporating ferromagnetic components 216, 218 disposed about respective charging coils 210, 212 according to at least one aspect of the present disclosure. In the simplified representation shown in FIG. 2, the wireless charging system 200 includes a portable electronic device 204 and a wireless charging device 202. The portable electronic device 204 can be positioned on a charging surface 208 of the wireless charging device 202. The wireless charging device 202 can be any device that is configured to generate time-varying magnetic flux to induce a current in a suitably configured receiving device.

The portable electronic device 204 can include a charging coil 210 and the wireless charging device 202 can include a charging coil 212 (e.g., inductive charging coils 210 and 212). To enable wireless power transfer, the charging coils 210, 212 can operate to transfer power therebetween. For example, the charging coil 212 can be a transmitter coil that generates a time-varying magnetic flux 214 and the charging coil 210 can be a receiver coil in which an electric current is induced in response to the time-varying magnetic flux 214. The induced electric current can be used to charge a battery of the portable electronic device 204, provide operating power to a component of the portable electronic device 204, and/or for other purposes as desired.

In various aspects, the portable electronic device 204 can be configured for reverse wireless charging. In this aspect, the charging coil 210 can be configured to act as both a receiver coil and a transmitter coil. For example, a battery of the portable electronic device 204 may be charged by wireless power transfer from the wireless charging device 202, with the charging coil 210 of the portable electronic device 204 acting as a receiver coil. Further, the portable electronic device 204 may be configured to use the battery to generate a current through the charging coil 210 to generate a time-varying magnetic flux 214 by the charging coil 210, thereby acting as a transmitter coil. The time-varying magnetic flux 214 generated by the charging coil 210 can induce an electric current in a suitably matched receiver coil, such as the card charging coil 132 of the vicinity use card 100 described below with respect to FIG. 4.

Referring again to FIG. 2, to enable efficient wireless power transfer, it is desirable to align the charging coils 212, 210. In some aspects, a magnetic alignment system 206 can provide such alignment. In the example shown in FIG. 2, the magnetic alignment system 206 can include a ferromagnetic component 218 disposed within or on a surface of the portable electronic device 204 and a ferromagnetic component 216 disposed within or on a surface of the wireless charging device 202. The ferromagnetic components 216 and 218 can be configured to magnetically attract one another into an aligned position that can cause the charging coils 210 and 212 to be aligned.

In various aspects, either ferromagnetic component 216, 218 can be formed of one or more than one magnet, such as arcuate magnets arranged in an annular configuration (e.g., an array of arcuate magnets arranged in an annular configuration). In some aspects, each of the arcuate magnets can have its magnetic polarity oriented in a desired direction so that magnetic attraction between the ferromagnetic component 216, 218 provides a desired alignment. In some aspects, either ferromagnetic component 216, 218 can include one or more than one magnet that can include a first magnetic region with a magnetic polarity oriented in a first direction and a second magnetic region with a magnetic polarity oriented in a second direction different from (e.g., opposite to) the first direction.

FIG. 3 illustrates a portable electronic device 102 that includes a wireless charging system 110 configured for reverse wireless charging, according to at least one aspect of the present disclosure. In some aspects, the wireless charging system 110 is encased within an outer housing of the portable electronic device 102 and therefore may not be visible when looking at the assembled portable electronic device 102. For illustrative purposes, FIG. 3 shows the position of the wireless charging system 110 within the portable electronic device 102. The wireless charging system 110 can include a reverse wireless charging controller 140, a device charging coil 104, and a ferromagnetic component 106 disposed about the device charging coil 104. The portable electronic device 102 can be similar in many respects to the portable electronic device 204 of FIG. 2. For example, the device charging coil 104 can be similar to the charging coil 210 and the ferromagnetic component 106 can be similar to the ferromagnetic component 218.

The reverse wireless charging controller 140 can be configured to control the generation of current in the device charging coil 104 and therefore control the generation of magnetic flux by the device charging coil 104. For example, the reverse wireless charging controller 140 can cause the device charging coil 104 to generate a magnetic flux when the portable electronic device 102 is positioned proximate to a suitably matched receiver coil of a receiving device (e.g., the card charging coil 132 of the vicinity use card 100 described below with respect to FIG. 4). Further, the reverse wireless charging controller 140 can cause the device charging coil 104 to stop generating the magnetic flux when the receiving device is fully charged and/or when the receiving device is removed from the proximity of the portable electronic device 102. Thus, the reverse wireless charging controller 140 can control wireless power transfer from the portable electronic device 102 to a receiving device. Various aspects of the reverse wireless charging controller 140 are in detail below with respect to FIG. 7.

Referring again to FIG. 3, in some aspects, the wireless charging system 110 can further include a ferromagnetic alignment component 108 that can be configured to rotationally align the portable electronic device 102 relative to a wireless charging device and/or a receiving device. For example, the ferromagnetic alignment component 108 may act to ensure that the elongated edges of the portable electronic device 102 are rotationally oriented in a desired position with respect to a wireless charging device (e.g., the wireless charging device 202 of FIG. 2) and/or a receiving device (e.g., the vicinity use card 100 of FIG. 4).

Although FIG. 3 depicts the ferromagnetic alignment component 108 and the ferromagnetic component 106 in a specific configuration (e.g., a strip of ferromagnetic material disposed proximately to a ring of ferromagnetic material that surrounds the device charging coil 104), the wireless charging system 110 may include various other configurations of the ferromagnetic alignment components 106, 108. For example, the ferromagnetic component 106 can include an array of multiple ferromagnetic components disposed about the device charging coil 104, for example, in a linear configuration, a polygonal configuration (e.g., a polygon with 3, 4, 5, 6, 7, 8, or more than 8 sides), or a ring configuration. As another example, the ferromagnetic alignment component 108 may include an array of multiple ferromagnetic components positioned relative to the ferromagnetic component 106, for example, in a linear configuration, a polygonal configuration (e.g., a polygon with 3, 4, 5, 6, 7, 8, or more than 8 sides), or a ring configuration. As yet another example, the ferromagnetic alignment component 108 may be omitted from the wireless charging system 110.

Having described illustrative examples of various portable electronic devices, wireless charging systems configured for reverse wireless charging, and ferromagnetic components included in the portable electronic devices and/or the wireless charging systems, the disclosure now turns to various cards (e.g., vicinity use cards) that can wirelessly receive power transferred from the portable electronic devices and other wireless charging devices.

FIG. 4 illustrates a vicinity use card 100, according to at least one aspect of the present disclosure. The vicinity use card 100 can include a card charging coil 132, a capacitor 136, and a circuit 130. The card charging coil 132 can be configured to act as a receiving coil for wireless power transfer from a suitably matched transmitter coil. For example, referring to FIG. 3 and FIG. 4, the card charging coil 132 can produce a current from magnetic flux generated by the device charging coil 104 of the portable electronic device 102 during reverse wireless charging. As another example, referring to FIG. 2 and FIG. 4, the card charging coil 132 can generate a current induced by the magnetic flux generated by a transmitter coil of a wireless charging device, such as the time-varying magnetic flux 214 generated by the coil 212 of the wireless charging device 202.

Returning to FIG. 4, the capacitor 136 can be electrically coupled to the card charging coil 132 and can be charged with current produced by the card charging coil 132. For example, referring again to FIG. 3 and FIG. 4, the capacitor 136 can be charged by wirelessly transferring power from the portable electronic device 102 via the device charging coil 104 to the vicinity use card 100 via the card charging coil 132. As another example, referring to FIG. 2 and FIG. 4, the capacitor 136 can be charged by wirelessly transferring power from the wireless charging device 202 via the coil 212 to the vicinity use card 100 via the card charging coil 132.

Returning to FIG. 4, the circuit 130 can be configured to control charging and discharging of the capacitor 136. In some aspects, the circuit 130 can control the charging and discharging of the capacitor 136 based on the proximity (e.g., the vicinity) of the vicinity use card 100 to a wireless charging device, such as the portable electronic device 102 (FIG. 3). For example, referring again to FIGS. 1A-1B, FIG. 3 and FIG. 4, the circuit 130 can be configured to cause the capacitor 136 to charge when the vicinity use card 100 is attached to the portable electronic device 102 (FIG. 1A) and cause the capacitor 136 to discharge upon removal of the vicinity use card 100 from the portable electronic device 102 (FIG. 1B).

Returning to FIG. 4, in some aspects, the circuit 130 can include a wireless charging controller 134. The wireless charging controller 134 can be configured to detect whether the vicinity use card 100 is proximate to a wireless charging device, and based on the detected proximity of the vicinity use card 100 to the wireless charging device, control the charging and discharging of the capacitor 136. For example, referring again to FIG. 3 and FIG. 4, the wireless charging controller 134 of the vicinity use card 100 can be configured to wirelessly communicate with the reverse wireless charging controller 140 of the portable electronic device 102. The wireless charging controller 134 can determine whether the vicinity use card 100 is attached to portable electronic device 102 based on communication between the wireless charging controller 134 and the reverse wireless charging controller 140.

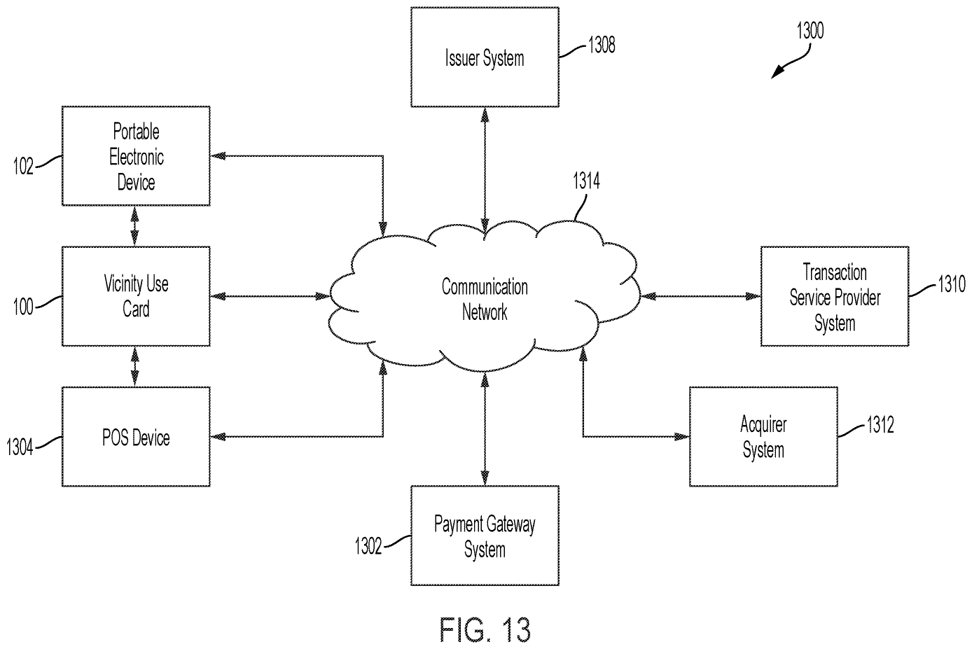

Returning to FIG. 4, in some aspects, the circuit 130 can be configured to detect a discharge level of the capacitor 136. For example, as noted above, the circuit 130 can include the wireless charging controller 134. The wireless charging controller 134 can be configured to measure a voltage across the capacitor 136 and determine the discharge level of the capacitor 136 based on the measured voltage. In other aspects, a device usable with the vicinity use card 100, such as an access device (e.g., the POS device 1304 of FIG. 13) can be configured to determine the discharge level of the capacitor 136.

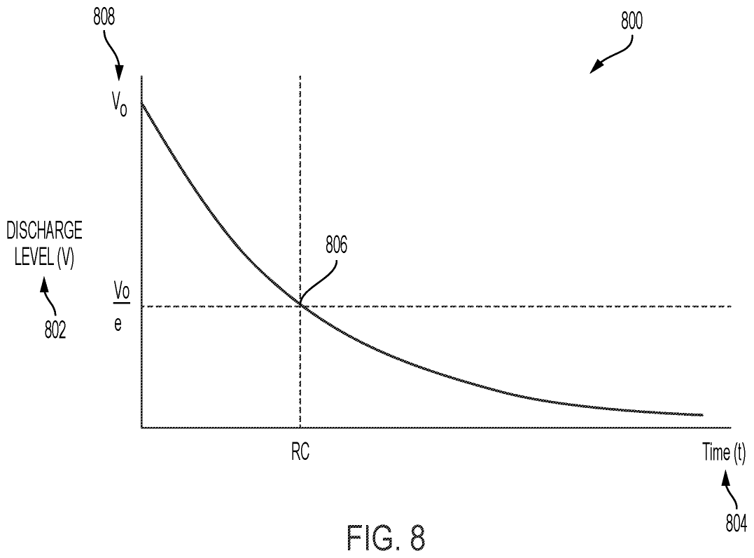

As explained in more detail below with respect to FIG. 8, the total time required for a capacitor to discharge can be predetermined based on the initial voltage across the capacitor when it is charged, the capacitance of the capacitor, and the resistance of the discharge path of the circuit that includes the capacitor. Further, the time required for the capacitor to reach a specific discharge level (e.g., a specific voltage) can be predetermined based on the initial voltage across the capacitor when it is charged, the capacitance of the capacitor, and the resistance of the discharge path of the circuit that includes the capacitor. Accordingly, capacitor discharge level can be correlated with capacitor discharge time.

Thus, referring again to FIGS. 3 and 4, the discharge level (e.g., the voltage) of the capacitor 136 detected by the circuit 130 can be used to determine the capacitor 136 discharging period. Further, as explained above, the circuit 130 can be configured to cause the capacitor 136 to start discharging upon removal of the vicinity use card 100 from the portable electronic device 102. Therefore, the discharge level of the capacitor 136 detected by the circuit 130 can be used to determine how long the vicinity use card 100 has been removed from the portable electronic device. The discharge level of the capacitor 136 can thus serve as a proxy for determining whether the vicinity use card 100 is within the vicinity of the portable electronic device 102 (e.g., because the vicinity use card 100 can be carried further away from the portable electronic device 102 the longer the vicinity use card 100 has been detached from portable electronic device 102).

Returning to FIG. 4, the circuit 130 can be configured to implement a security action based on the discharge level of the capacitor 136 reaching a discharge level threshold. In some aspects, the circuit 130 may include an integrated circuit 138 configured to implement the security action based on the discharge level of the capacitor 136 reaching a discharge level threshold. For example, the vicinity use card 100 may be used to conduct a transaction (e.g., the vicinity use card 100 can be a payment card used to conduct a financial transaction). The security action implemented by the integrated circuit 138 based on the discharge level of the capacitor 136 reaching a discharge level threshold can include preventing a transaction from being completed using the vicinity use card 100 or requiring verification (e.g., a personal identification number (PIN)) to complete a transaction using the vicinity use card 100. In other aspects, a device usable with the vicinity use card 100, such as an access device (e.g., the POS device 1304 of FIG. 13), can be configured to implement a security action based on the discharge level of the capacitor 136 reaching a discharge level threshold. For example, the access device may prevent a transaction from being completed using the vicinity use card 100 based on detecting that the discharge level of the capacitor 136 has reached a discharge threshold level. As another example, the access device may require a PIN in order to complete a transaction using the vicinity use card 100 based on detecting that the discharge level of the capacitor 136 has reached a discharge level threshold.

Referring again to FIGS. 3 and 4, the discharge level threshold and the security action can be selected to enhance security related to the use of the vicinity use card 100. For example, the discharge threshold level and security action can be selected such that a transaction conducted using the vicinity use card 100 can be completed only within a predetermined period after removing the vicinity use card 100 from the portable electronic device 102. As another example, the discharge threshold level and security action can be selected such that, after the vicinity use card 100 has been removed from the portable electronic device for a predetermined period, further verification (e.g., a PIN) is required to conduct a transaction using the vicinity use card 100.

In some aspects, the circuit 130 and the capacitor 136 are configured so that the capacitor 136 fully discharges over a predetermined total discharge time (e.g., at a predetermined discharge rate), such as, for example, a predetermined total discharge time in a range of 30 seconds to 1,800 seconds, 60 seconds to 900 seconds, 120 seconds to 450 seconds, or 120 seconds to 240 seconds, and/or a predetermined discharge time of 60 seconds, 80 seconds, 100 seconds, 120 seconds, 140 seconds, 160 seconds, 180 seconds, 200 seconds, 220 seconds, 240 seconds, 260 seconds, 280 seconds, 300 seconds, 320 seconds, 340 seconds, or 360 seconds. The discharge level threshold may be based on a discharge time in a range of, for example, 15 seconds to 900 seconds, 30 seconds to 450 seconds, 60 seconds to 225 seconds, or 60 seconds to 120 seconds, and/or a discharge time of 30 seconds, 40 seconds, 50 seconds, 60 seconds, 70 seconds, 80 seconds, 90 seconds, 100 seconds, 120 seconds, 130 seconds, 140 seconds, 150 seconds, 160 seconds, 170 seconds, or 180 seconds. As explained in more detail below with respect to FIGS. 7 and 8, the circuit 130 and/or the capacitor 136 can be configured to have a capacitance (C), a resistance (R), and/or a fully charged voltage (Vₒ) that achieves a desired total discharge time and/or a desired discharge rate.

Implementing a security action based on the discharge level of the capacitor 136 reaching a discharge threshold level can prevent a fraudster who may have stolen the vicinity use card 100, without the ability to recharge the capacitor 136 with the portable electronic device 102, from using the vicinity use card 100 to conduct a transaction. Further, waiting to implement the security action based on the discharge level of the capacitor 136 reaching a discharge level threshold can provide convenience to a non-fraudulent user of the vicinity use card 100. For example, the circuit 130 and the capacitor 136 may be configured with a predetermined total discharge time in a range of 120 seconds to 450 seconds and may be configured to implement a security action based on a discharge level threshold corresponding to a discharge time in a range of 60 seconds to 225 seconds. Waiting to implement the security action based on the discharge time in a range of 120 seconds to 450 seconds (e.g., 2 minutes, 3 minutes, 4 minutes, 5 minutes) can allow the user enough time to remove the vicinity use card 100 from the user's portable electronic device 102 and conduct a transaction without the security action being implemented. However, in a situation where a fraudster has found or stolen the user's vicinity use card 100, at least 120 seconds to 450 seconds will likely have passed from the time the vicinity use card 100 was removed from the user's portable electronic device 102 to the time when the fraudster tries to fraudulently use the vicinity use card 100. Accordingly, implementing the security action based on a discharge time in a range of 120 seconds to 450 seconds (e.g., 2 minutes, 3 minutes, 4 minutes, 5 minutes) can prevent the fraudster from conducting a transaction using the vicinity use card 100.

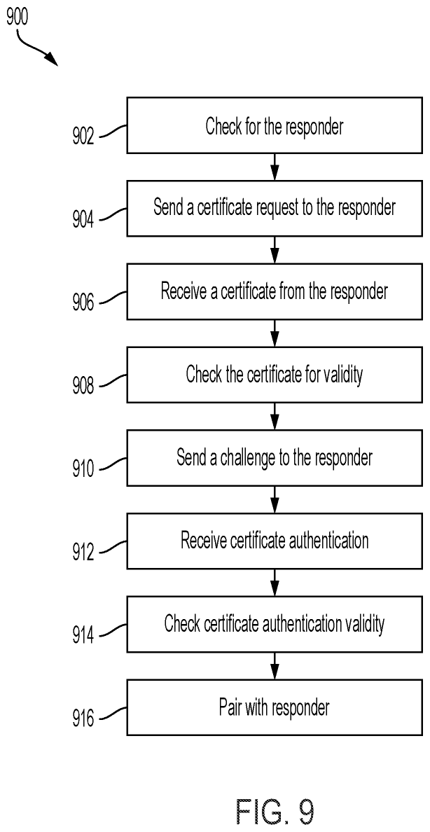

Further, as explained in detail below with respect to FIG. 7 and FIG. 9, the vicinity use card 100 may be paired with one or more than one specific portable electronic device 102 such that only the one or more than one specific portable electronic device 102 can be used to charge the capacitor 136. For example, the circuit 130 of the vicinity use card 100 can be configured to communicate with the portable electronic device 102 (e.g. via antennas 702, 722 of FIG. 7). Based on this communication, the circuit 130 and the portable electronic device 102 can implement a pairing process (e.g., the authentication protocol 900 of FIG. 9). Upon successful completion of the pairing process, the circuit 130 can thereafter recognize the portable electronic device 102 as a paired and/or authenticated charging device. Additionally or alternatively, the portable electronic device 102 can thereafter recognize the circuit 130 as being associated with a paired and/or authenticated vicinity use card 100.

Continuing with the example above, the circuit 130 can be configured to communicate with the portable electronic device 102 upon later attachment of the vicinity use card 100 to the portable electronic device 102 to determine that the portable electronic device 102 is a paired and/or authenticated charging device. The circuit 130 can be further configured to allow and/or cause the capacitor 136 to be charged by the portable electronic device 102 based on determining that the portable electronic device 102 is a paired and/or authenticated charging device. Additionally or alternatively, the portable electronic device 102 can be configured to communicate with the circuit 130 upon later attachment of the vicinity use card 100 to the portable electronic device 102 to determine that the circuit 130 is associated with a paired and/or authenticated vicinity use card 100. The portable electronic device 102 can further be configured to allow and/or cause the capacitor 136 to be charged by the portable electronic device 102 based on determining that the circuit 130 is associated with a paired and/or authenticated vicinity use card 100. Further, the circuit 130 and/or the portable electronic device 102 can be configured to prevent and/or not cause the capacitor 136 to be charged by the portable electronic device 102 based on determining the circuit 130 and the portable electronic device 102 have not been paired and/or authenticated. Accordingly, in some aspects, a fraudster who may have stolen the vicinity use card 100 cannot recharge the capacitor 136 using a wireless charging device or a portable electronic device that has not been paired and/or authenticated with the vicinity use card 100.

Returning to FIG. 4, in some aspects, the vicinity use card 100 may be a payment card. Thus, in some aspects, the integrated circuit 138 may be an Europay Mastercard Visa (EMV) chip. The integrated circuit 138 (e.g., the EMS chip) may implement the security action by communicating with an access device (e.g., POS device 1304 of FIG. 13). For example, upon attempting to conduct a transaction using the vicinity use card 100 and a POS device, the POS device may send a SELECT command to the vicinity use card 100. In aspects where the security action includes preventing a transaction using the vicinity use card 100, in response to the SELECT command, the integrated circuit 138 can be configured to cause a PPSE (Proximity Payment System Environment) application, a PSE (Payment System Environment) application, and/or an EMV payment application to return an error status (e.g., word 6A82). In aspects where the security action includes requiring verification to complete a transaction using the vicinity use card 100, in response to the SELECT command, the integrated circuit 138 can be configured to cause an EMV payment application to return a record including a CVM (cardholder verification method) list in which an online PIN is set and NoCMV (no cardholder verification method) is removed.

In some aspects, the circuit 130 (e.g., the wireless charging controller 134 and/or the integrated circuit 138) can include one or more than one a data storage medium (e.g., volatile and/or non-volatile memory). The one or more than one data storage medium can store information and/or instructions that may be executed to implement any of the pairing processes (e.g., the authentication protocol 900 of FIG. 9) described herein, any of the securing actions described herein, and/or any of the functions described herein as being performed by the circuit 130. For example, the wireless charging controller 134 may include a data storage medium storing instructions that are executable to pair the wireless charging controller 134 with the portable electronic device 102, to detect a discharge level of the capacitor 136, to determine that the discharge level of the capacitor 136 has reached a discharge level threshold, and/or to cause a security action to be implemented based on determining that the discharge level of the capacitor 136 has reached the discharge level threshold. As another example, the integrated circuit 138 may include a data storage medium storing instructions that are executable to communicate with an access device to conduct a transaction and/or implement a security action.

In some aspects, the vicinity use card 100 can include an NFC antenna 150 (near field communication antenna). The NFC antenna 150 is electrically coupled to the integrated circuit 138 and can enable wireless communication between the integrated circuit 138 and an access device (e.g., a POS device). An illustrative block diagram of the circuit 130 and other components of the vicinity use card 100 are described below with respect to the block circuit diagram illustrated in FIG. 7, according to at least one aspect of the present disclosure.

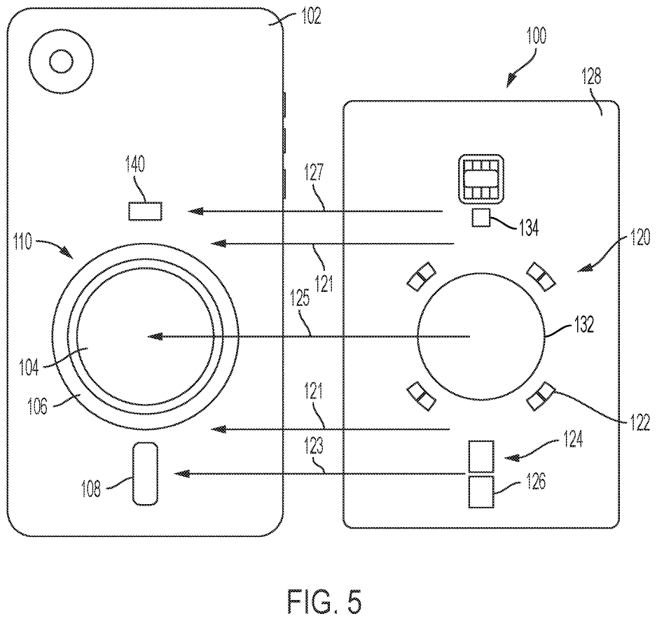

Returning to FIG. 4, the vicinity use card 100 can include one or more than one magnet 122 (e.g., a magnet array 120) for removably attaching the vicinity use card 100 to a portable electronic device. Further, in some aspects, the vicinity use card 100 can include one or more than one alignment magnet 126 (e.g. an alignment magnet array 124) to align the vicinity use card 100 relative to a wireless charging device (e.g. a portable electronic device). Various aspects of the magnet(s) 122, magnet array 120, alignment magnet(s) 126, and alignment magnet array 124 are described in detail below with respect to FIG. 5.

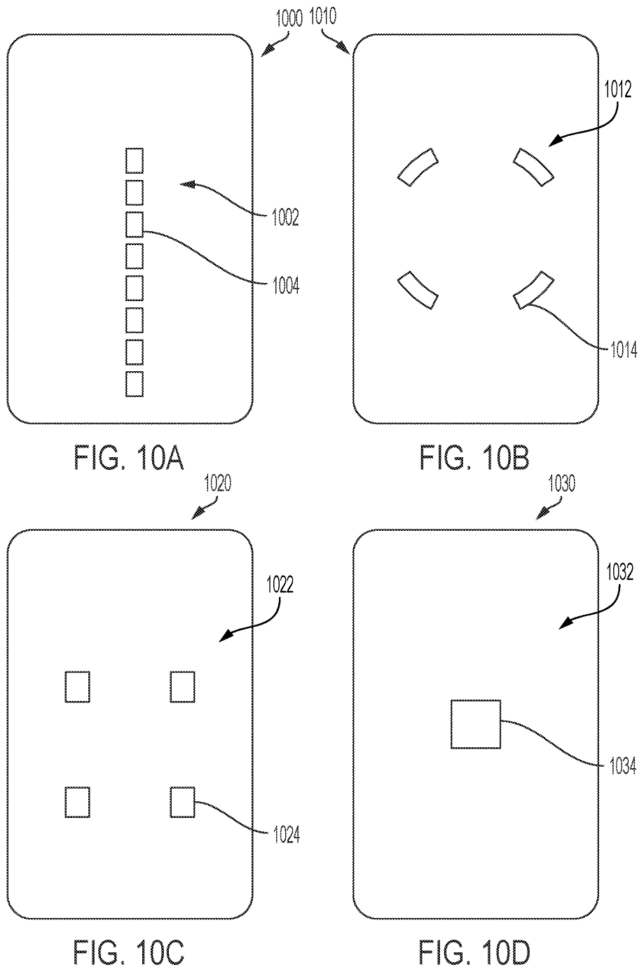

FIG. 5 illustrates a vicinity use card 100 removably attaching to a portable electronic device 102, according to at least one aspect of the present disclosure. As noted above, the vicinity use card 100 can include a magnet 122. The magnet 122 can be supported by the substrate 128. The magnet 122 can be configured to magnetically couple to the ferromagnetic component 106 of the portable electronic device 102. In the non-limiting aspect of FIG. 5, the vicinity use card 100 includes multiple magnets 122 forming a magnet array 120 that complements the ring configuration of the ferromagnetic component 106 of the portable electronic device 102. In other aspects, the vicinity use card 100 can include other magnet 122 and/or magnet array 120 configurations. For example, the vicinity use card 100 can include any of the magnet and/or magnet array configurations described in detail below with respect to FIGS. 10-10D, such as a linear configuration, a polygonal configuration (e.g., a polygon with 3, 4, 5, 6, 7, 8, or more than 8 sides), a ring configuration, or any other suitable configuration that defines a profile that complements a ferromagnetic component included in a portable electronic device. In some aspects, the magnet 122 and/or magnet array 120 are configured to align the card charging coil 132 with the device charging coil 104 to enable efficient wireless power transfer from the device charging coil 104 to the card charging coil 132 when the vicinity use card 100 is removably attached to the portable electronic device 102.

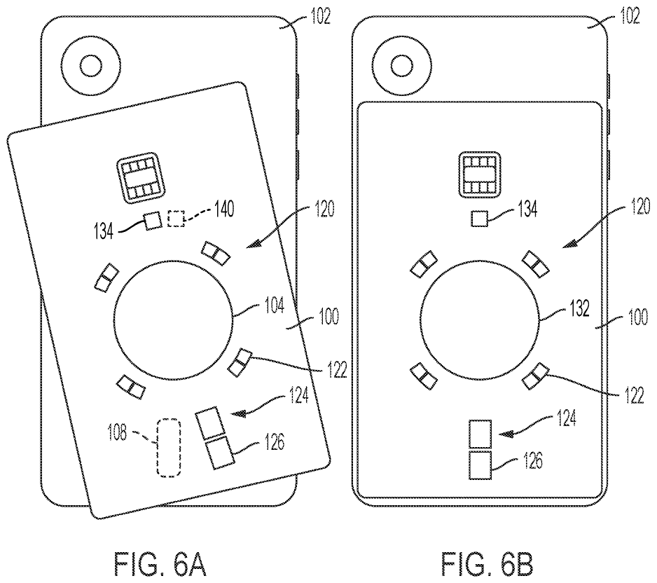

In various aspects, the vicinity use card 100 can include an alignment magnet 126 supported by the substrate 128. The alignment magnet 126 can be configured to magnetically couple to the ferromagnetic alignment component 108 of the portable electronic device 102 to align the vicinity use card 100 relative to the portable electronic device 102, for example, as described in detail below with respect to FIGS. 6A-6B. In the non-limiting aspect of FIG. 5, the vicinity use card 100 includes multiple alignment magnets 126 forming an alignment magnet array 124. In other aspects, the vicinity use card 100 can include other alignment magnet 126 and/or alignment magnet array 124 configurations. For example, the alignment magnet(s) 126 and/or the alignment magnet array 124 can be configured to define a profile that complements any of the various ferromagnetic alignment component 108 configurations that may be used in the portable electronic device 102. Accordingly, the alignment magnet(s) 126 and/or the alignment magnet array 124 can define, for example, a linear configuration, a polygonal configuration (e.g., a polygon with 3, 4, 5, 6, 7, 8, or more than 8 sides), a ring configuration, or any other suitable configuration. In yet other aspects, the alignment magnet(s) 126 and/or the alignment magnet array 124 may be omitted from the vicinity use card 100. In some aspects, the alignment magnet(s) 126 and/or the alignment magnet array 124 are configured to align the wireless charging controller 134 with the reverse wireless charging controller 140. Ensuring proper alignment of the wireless charging controller 134 with the reverse wireless charging controller 140 can enable efficient wireless communication therebetween. Additionally or alternatively, ensuring proper alignment of the wireless charging controller 134 with the reverse wireless charging controller 140 can allow the wireless charging controller 134 and/or the reverse wireless charging controller 140 to detect that the vicinity use card 100 is attached to the portable electronic device 102.

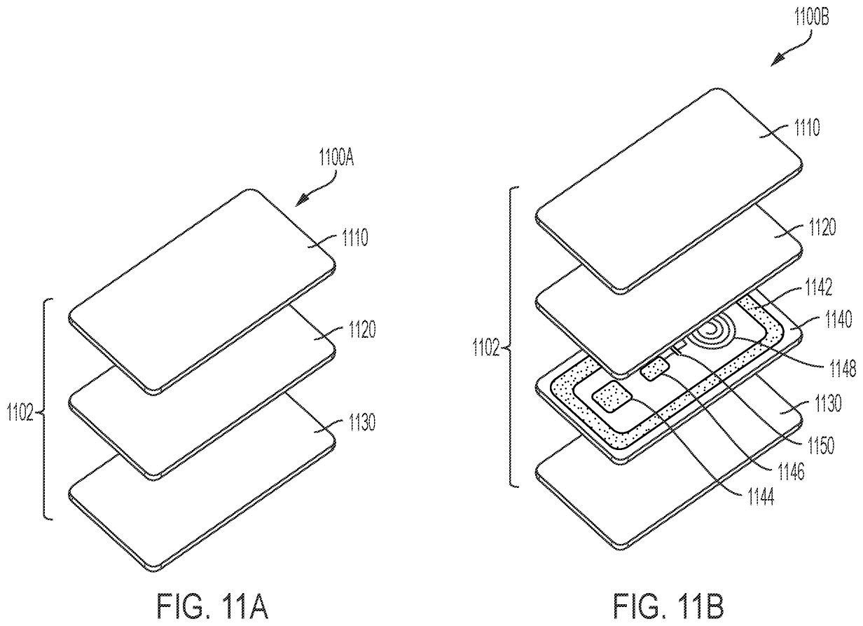

The substrate 128 can refer to any layer that forms part of the body of the vicinity use card 100 (e.g., the card body) or the substrate 128 can refer to the entire card body of the vicinity use card 100. For example, as described in detail below with respect to FIGS. 11A-11B, the vicinity use card 100 can be constructed using one or more than one layer of material. Thus, in aspects where the vicinity use card 100 includes multiple layers of material, the substrate 128 can be formed of any one or more than one of the layers, such as, for example, all of the layers. In aspects where the vicinity use card 100 includes only a single layer of material, the substrate 128 can be the single layer of material. Examples of suitable materials for the substrate 128 and/or the layers thereof are described with respect to FIGS. 11A-11B.

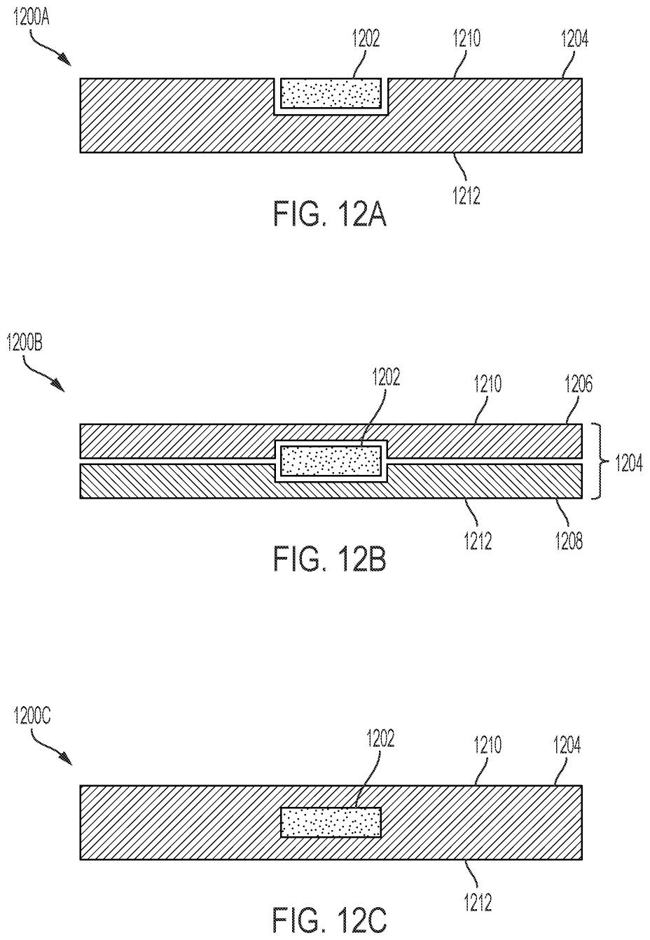

In various aspects, the magnet(s) 122 and/or the alignment magnet(s) 126 can be embedded in the substrate 128. For example, as described in detail below with respect to FIG. 12A-12C, the substrate 128 may define a first surface and a second surface opposite the first surface. The vicinity use card 100 can be configured such that neither the magnet(s) 122 nor the alignment magnet(s) 126 protrude beyond the first surface or the second surface of the substrate 128. In one aspect, any of the magnet(s) 122 and/or the alignment magnet(s) 126 can be substantially flush with the first surface and/or the second surface of the substrate 128. Thus, the magnet(s) 122 and/or the alignment magnet(s) 126 may be visible when looking at the assembled vicinity use card 100 (e.g., as shown in FIG. 5). In another aspect, any of the magnet(s) 122 and/or the alignment magnet(s) 126 can be embedded between the first surface and the second surface (e.g., fully embedded within the substrate 128). Thus, the magnet(s) 122 and/or the alignment magnet(s) 126 may not be visible when looking at the assembled vicinity use card 100.

Embedding the magnet(s) 122 and/or the alignment magnet(s) 126 in the substrate 128 can allow the vicinity use card 100 to be inserted into an access device (e.g., swiped across a magnetic stripe reader of a POS device, dipped into a chip reader of a POS device, etc.). For example, inserting the vicinity use card 100 into an access device may require that a first surface and a second surface (e.g., a front surface and a back surface) of the vicinity use card 100 be substantially flat so that the vicinity use card 100 can be smoothly swiped across or dipped into the access device. If the magnet(s) 122 and/or the alignment magnet(s) 126 protruded beyond the first surface and or the second surface of the vicinity use card 100, then the magnet(s) 122 and/or the alignment magnet(s) 126 could contact the access device and potentially prevent the vicinity use card 100 from being smoothly swiped or dipped therein. In some aspects, this may prevent the vicinity use card 100 from being fully swiped or dipped and could ultimately prevent the access device from reading information stored on the vicinity use card 100. Thus, embedding the magnet(s) 122 and/or the alignment magnet(s) 126 in the substrate 128 can allow the vicinity use card 100 to be being fully swiped across or dipped into an access device without causing physical interference through contact.

Still referring to FIG. 5, the magnet(s) 122 and/or the alignment magnet(s) 126 can enable the vicinity use card 100 to be removably attached to and/or aligned with the portable electronic device 102 by magnetically coupling with components of the wireless charging system 110. For example, as indicated by the arrows 121, the magnets 122 of the magnet array 120 can magnetically couple with the ferromagnetic component 106 of the wireless charging system 110. Similarly, as indicated by the arrow 123, the alignment magnets 126 of the alignment magnet array 124 can magnetically couple with the ferromagnetic alignment component 108 of the wireless charging system 110. Thus, in some aspects, the vicinity use card 100 can be configured to reliably attach to the portable electronic device 102 by taking advantage of various ferromagnetic components included in the portable electronic device 102 as part of a wireless charging system 110. Further, as noted above, coupling the magnet(s) 122 and/or the alignment magnet(s) 126 with components of the wireless charging system 110 can cause the card charging coil 132 to align with the device charging coil 104, as noted by the arrow 125. Similarly, coupling the magnet(s) 122 and/or the alignment magnet(s) 126 with components of the wireless charging system 110 can cause the wireless charging controller 134 to align with the reverse wireless charging controller 140, as noted by arrow 127.

FIGS. 6A-6B illustrate the vicinity use card 100 aligning relative to the portable electronic device 102 based on magnetic coupling of the alignment magnet(s) 126 to the ferromagnetic alignment component 108, according to at least one aspect of the present disclosure. As explained above, the magnets 122 of the magnet array 120 can magnetically couple with the ferromagnetic component 106 to removably attach the vicinity use card 100 to the portable electronic device 102. In some aspects, the vicinity use card 100 may not be aligned relative to the portable electronic device 102 even after the magnets 122 of the magnet array 120 are magnetically coupled with the ferromagnetic component 106. For example, as shown in FIG. 6A, the magnets 122 of magnet array 120 are magnetically coupled with the ferromagnetic component 106 (not shown in FIG. 6A) but the various edges of the vicinity use card 100 are not parallel with the various edges of the portable electronic device 102 and some corners of the vicinity use card 100 are exposed. Thus, the vicinity use card 100 is potentially susceptible to becoming inadvertently removed, for example, by an object contacting one of the exposed corners of the vicinity use card 100. Further, as shown in FIG. 6A, the wireless charging controller 134 may be improperly aligned with the reverse wireless charging controller 140.

Transitioning from FIG. 6A to FIG. 6B, as the alignment magnets 126 of the alignment magnet array 124 magnetically couple with the ferromagnetic alignment component 108, the vicinity use card 100 is rotationally aligned with the portable electronic device 102. This alignment configuration may cause the various edges of the vicinity use card 100 to be parallel or substantially parallel with the various edges of the portable electronic device 102 such that the corners of the vicinity use card 100 are not exposed. Accordingly, as a result of the alignment caused by the alignment magnet(s) 126 magnetically coupling with the ferromagnetic alignment component 108, the vicinity use card 100 may be less susceptible to becoming inadvertently removed from the portable electronic device 102. Furthermore, the wireless charging controller 134 is aligned with the reverse wireless charging controller 140 which can enable efficient wireless communication therebetween.

FIG. 7 illustrates a simplified block circuit diagram of a vicinity use card 100 and portable electronic device 102, according to at least one aspect of the present disclosure. Although specific controller and/or microprocessor configurations are shown in FIG. 7, the various controllers and microprocessors described herein may be implemented as a control circuit, control logic, a microprocessor, a microcontroller, logic, a LSI (large-scale integration) circuit, or a FPGA (field-programmable gate array), or various combinations thereof.

Referring still to FIG. 7, the portable electronic device 102 can include a controller 730, a reverse wireless charging controller 140, a power supply 732, and a device charging coil 104. The controller 730 can be configured to control the main functions of the portable electronic device 102 (e.g., portable electronic device 102 may be a smart phone and the controller 730 may be the smart phone's central processing unit). The power supply 732 can store energy to power to the portable electronic device 102. For example, the power supply 732 may include a battery that is chargeable via wireless charging using the device charging coil 104. The reverse wireless charging controller 140 can include a microprocessor 728 and an antenna 722 (e.g., an NFC antenna). Further, the reverse wireless charging controller 140 can be configured control power transfer from the power supply 732 to the vicinity use card 100 via the device charging coil 104. In some aspects, the reverse wireless charging controller 140 may include a crystal 726 (xtal) (e.g., a 27.12 MHz crystal oscillator) and a matching circuit 724. In some aspects, the reverse wireless charging controller 140 may be similar to the 13.57 MHz Wireless Charger Module produced by RHOM Co., Ltd. (Part Number BP3621).

Referring still to FIG. 7, the vicinity use card 100 can include a circuit 130, a capacitor 136, a card charging coil 132, and an NFC antenna 150. As shown in FIG. 7, the circuit 130 includes an integrated circuit 138 and a wireless charging controller 134 that is separate from the integrated circuit 138. In other aspects, the wireless charging controller 134 and the integrated circuit 138 may be included together as part of a single integrated circuit. In yet other aspects, the vicinity use card 100 may not include the integrated circuit 138. The integrated circuit 138 can be configured to communicate with an access device (e.g., POS device 1304 of FIG. 13) to conduct a transaction. For example, the integrated circuit 138 may be an EMV chip, such as an EMV chip configured according to an ISO/IEC (International Organization for Standardization/International Electrotechnical Commission) 7816 and/or an ISO/IEC14443 standard. The NFC antenna 150 can be electrically coupled to the integrated circuit 138 and can be configured to enable wireless communication between the integrated circuit and an access device (e.g., POS device 1304 of FIG. 13). Thus, in some aspects, the vicinity use card 100 may be configured as a contact card and/or a contactless card. The capacitor 136 can store electrical energy wirelessly transferred from the portable electronic device 102 via the device charging coil 104 to the vicinity use card 100 via the card charging coil 132.

Referring still to FIG. 7, the wireless charging controller 134 can include a microprocessor 708 and an antenna 702 (e.g., an NFC antenna) to enable wireless communication with the antenna 722 of reverse wireless charging controller 140. In some aspects the wireless charging controller 134 can further include a diode bridge 706 and a matching circuit 704. In some aspects, the wireless charging controller 134 may be similar to the 13.57 MHz Wireless Charger Module produced by RHOM Co., Ltd. (Part Number BP3622).

The wireless charging controller 134 can be configured to communicate with the reverse wireless charging controller 140 to control charging and discharging of the capacitor 136. For example, the wireless charging controller 134 and the reverse wireless charging controller 140 can determine when the vicinity use card 100 is attached to the portable electronic device 102 based on communication via the antennas 702, 722. Upon detecting that the vicinity use card 100 is attached to the portable electronic device 102, the wireless charging controller 134 and/or the reverse wireless charging controller 140 can cause the portable electronic device 102 to generate magnetic flux via the device charging coil 104. The magnetic flux generated by the device charging coil 104 can induce a current in the card charging coil 132 which is used to charge the capacitor 136.

Referring still to FIG. 7, the wireless charging controller 134 can be configured to detect the charge level of the capacitor 136. Upon detecting that the capacitor 136 is fully or near fully charged, the wireless charging controller 134 can communicate with the reverse wireless charging controller 140 to cause the portable electronic device 102 to stop generating magnetic flux via the device charging coil 104. Causing the portable electronic device 102 to stop generating magnetic flux via the device charging coil 104 when the capacitor 136 is fully or near fully charged can conserve energy stored by the power supply 732 (e.g., so that the power supply 732 is not continually outputting power to charge the capacitor 136 after the capacitor 136 is fully charged).

Referring still to FIG. 7, the wireless charging controller 134 and the reverse wireless charging controller 140 can determine when the vicinity use card 100 has been removed from the portable electronic device 102 based on communication via the antennas 702, 722. Upon detecting that the vicinity use card 100 has been removed from the portable electronic device 102, the wireless charging controller 134 can cause the capacitor 136 to begin to discharge. Further, the wireless charging controller 134 can be configured to detect a discharge level of the capacitor 136 (e.g., the voltage across the capacitor). Upon detecting that the discharge level of the capacitor 136 has reached a predetermined threshold, the wireless charging controller 134 can cause the integrated circuit 138 to implement a security action, as explained above with respect to FIG. 4. In some aspects, upon detecting that the vicinity use card 100 has been removed from the portable electronic device 102, the reverse wireless charging controller 140 can cause the portable electronic device 102 to stop generating magnetic flux via the device charging coil 104.

Returning to FIG. 7, the capacitor 136 and surrounding circuitry can be configured such that the capacitor 136 fully or near fully discharges from a fully or near fully charged state over a predetermined period (e.g., a predetermined total discharge time). The predetermined total discharge time can be selected based on the capacitance of the capacitor 136, the resistance of the circuitry along the discharge path of the capacitor 136, and the voltage at which the capacitor 136 is fully charged, as explained below with respect to FIG. 8.

FIG. 8 is a graph 800 illustrating the relationship between capacitor discharge level (V) 802 and discharge time (t) 804 based on a selected charged voltage (Vₒ) 808, resistance (R), and capacitance (C), according to at least one aspect of the present disclosure. Generally, the relationship between capacitor discharge level (V) 802 and discharge time (t) 804 can be represented by the following equation:

$$V = {V}_{o} {e}^{- ( \frac{t}{RC} )}$$

Therefore, based on this relationship, the discharge time required for capacitor to reach a given voltage can be determined based on the resistance (R) of the discharge path of the capacitor, the capacitance (C) of the capacitor, and the charged voltage (Vₒ) of the capacitor. For example, when discharge level V is equal to Vₒ/e (0.368 Vₒ), the discharge time t is equal to RC, as shown at 806 of graph 800.

Thus, referring to FIG. 7 and the relationship illustrated by graph 800 of FIG. 8, one of ordinary skill in the art can configure the circuit 130 and the capacitor 136 to have a capacitance (C), resistance (R), and fully charged voltage (Vₒ) to achieve a desired total discharge time. For example the circuit 130 and the capacitor 136 can be configured to have a capacitance (C), resistance (R), and fully charged voltage (Vₒ) to achieve a predetermined total discharge time in a range of 30 to 1,800 seconds, such as a predetermined total discharge time of 180 seconds. Further, the circuit 130 can be configured to implement the security action at a desired discharge time (t) by causing the security action to be implemented at a discharge level (V) threshold corresponding to the desired discharge time (t). For example, the discharge time (t) at which the security action is implemented may be selected based on the discharge level (V) reaching a discharge level threshold equal to 0.5 Vₒ (e.g., when the capacitor is half discharged). As another example, the discharge level (V) threshold may be selected based on a discharge time in a range of 15 seconds to 900 seconds, such as a discharge time of 90 seconds.

Returning to FIG. 7, the wireless charging controller 134 and/or the reverse wireless charging controller 140 can be configured to cause the capacitor 136 to charge only after pairing (e.g., authentication). For example, in some aspects, wireless charging controller 134 is configured to communicate to the reverse wireless charging controller 140 an authentication certificate that that is validated by the reverse wireless charging controller 140 to authenticate the vicinity use card 100. Thus, the portable electronic device 102 can be configured to generate magnetic flux from the device charging coil 104 only after the vicinity use card 100 has been authenticated by the portable electronic device 102. As another example, in some aspects, the reverse wireless charging controller 140 is configured to communicate to the wireless charging controller 134 an authentication certificate that that is validated by the wireless charging controller 134 to authenticate the portable electronic device 102. Thus, the wireless charging controller 134 can be configured to cause the capacitor 136 to charge only after the portable electronic device 102 has been authenticated. In some aspects, in addition to or in lieu of the above, communication (e.g., authentication) between the portable electronic device 102 an issuer of the vicinity use card 100 (e.g., via the issuer system 1308 of FIG. 13) is required for authentication and/or pairing between the portable electronic device 102 and the vicinity use card 100.

FIG. 9 illustrates an authentication protocol 900 that may be executed by the wireless charging controller 134 and/or the reverse wireless charging controller 140 of FIG. 7, in accordance with various aspects of the present disclosure. In some aspects, the wireless charging controller 134 may be configured to cause the capacitor 136 to charge only after completion of the authentication protocol 900. In some aspects, the portable electronic device 102 may be configured to generate magnetic flux from the device charging coil 104 only after completion of the authentication protocol.

Referring still to FIG. 7 and FIG. 9, the authentication protocol 900 references a “sender” and a “receiver.” In some aspects, the wireless charging controller 134 can be the sender and the reverse wireless charging controller 140 can be the receiver. In other aspects, the reverse wireless charging controller 140 can be the sender and the wireless charging controller 134 can be the receiver.

Referring now to FIG. 9, according to the authentication protocol 900, the sender checks 902 for the responder (e.g., check peer's feature support) and sends 904 a certificate request (e.g., send GET_CERTIFICATE for slot 0) to the responder. The sender receives 906 a certificate from the responder (e.g., receive CERTIFICATE). Further, the sender checks 908 the certificate for validity (e.g., check CERTIFICATE chain validity) and sends 910 a challenge (e.g., send CHALLENGE for slot 0) to the responder. The sender receives 912 certificate authentication (e.g., receive CERTIFICATE AUT). Further, the sender checks 914 the certificate authentication validity (e.g., check CHALLENGE signature's validity). Upon successful completion of the authentication protocol 900, the responder is paired 916 with the sender.

Referring again to FIG. 7, in some aspects, the circuit 130 (e.g., the wireless charging controller 134 and/or the integrated circuit 138) can include one or more than one a data storage medium (e.g., volatile and/or non-volatile memory) to store information and/or instructions that may be executed to implement any of the pairing processes (e.g., the authentication protocol 900 of FIG. 9) described herein, any of the securing actions described herein, and/or any of the functions described herein as being performed by the circuit 130.

FIGS. 10A-10D respectively illustrate vicinity use cards 1000, 1010, 1020, 1030 including various magnet arrays. Any aspects of the vicinity use cards 1000, 1010, 1020, 1030 can be included in the vicinity use card 100 described above (and vice versa). As noted above with respect to FIG. 5, the magnet(s) 122 and/or the magnet array 120 can define a linear configuration, a polygonal configuration (e.g., a polygon with 3, 4, 5, 6, 7, 8, or more than 8 sides), or a ring configuration. FIG. 10A illustrates one example of a magnet array 1002 including magnets 1004 that define a linear configuration. FIG. 10B illustrates one example of a magnet array 1012 including magnets 1014 that define a ring configuration. FIG. 10C illustrates one example of a magnet array 1022 including magnets 1024 that define a polygonal configuration with 4 sides. FIG. 10D illustrates one example of a magnet array 1032 that includes a single magnet 1034. As shown in FIGS. 10A-10D, the magnets 1004, 1014, 1024, 1034 are substantially flush with an outer surface of the respective vicinity use card 1000, 1010, 1020, 1030. Alternatively, any one or more than one of the magnets 1004, 1014, 1024, 1034 can be wholly embedded in the respective vicinity use card 1000, 1010, 1020, 1030.

The number, shape, and size of the magnets 1004, 1014, 1024, 1034 in the magnet arrays 1002, 1012, 1022, 1032 depicted in FIGS. 10A-10D are provided for illustrative purposes. Similarly, the depictions of the position of the magnets 1004, 1014, 1024, 1034 within the vicinity use cards 1000, 1010, 1020, 1030 and the position of the magnets 1004, 1014, 1024, 1034 relative to each other are provided for illustrative purposes. The position of any of the magnet arrays 1002, 1012, 1022, 1032 can be shifted, rotated, and/or otherwise modified. Further, any of the magnet arrays disclosed herein (e.g., magnet arrays 1002, 1012, 1022, 1032) can include any number (any positive integer greater than or equal to one) of magnets. The magnets included in any a particular magnet array can all be the same size and shape or can have varying sizes and/or shapes. For example, the magnets included in a particular magnet array can have any combination of arcuate (e.g., arc-shaped, curve-shaped, similar to magnets 1014 of FIG. 10B), square-shaped (e.g., similar to magnet 1034 of FIG. 10D), rectangular-shaped (e.g., similar to magnets 1004 of FIG. 10A), circle-shaped, ellipse-shaped, polygon-shaped, and/or other suitably shaped magnets. Further, the alignment magnet(s) and the alignment magnet arrays disclosed herein (e.g., alignment magnet(s) 126, alignment magnet array 124) can be configured similarly to any of the magnets and magnet arrays (e.g., magnets 1004, 1014, 1024, 1034, magnet arrays 1002, 1012, 1022, 1032) disclosed herein.

In some aspects, any of the magnets disclosed herein (e.g., magnet(s) 122, alignment magnet(s) 124, magnets 1004, 1014, 1024, 1034) can be made of a magnetic material such as an neodymium-iron-boron (NdFeB), other rare earth magnetic materials, or other materials (e.g., ferromagnetic materials) that can be magnetized to create a persistent magnetic field. In some aspects, any of the magnets disclosed herein can have a monolithic structure having a single magnetic region with a magnetic polarity aligned in a direction normal to a first surface and a second surface (e.g., a front and back surface) of the vicinity use card (e.g., vicinity use card 100, 1000, 1010, 1020, 1030).

For example, referring again to FIG. 5, in some aspects, each of the magnets 122 can be a bar magnet that has been ground and shaped into an arcuate structure. The substrate 128 can have a first surface and a second surface opposite the first surface (e.g., a surface facing towards the portable electronic device 102 and a surface facing away from the portable electronic device 102). Each of the magnets 122 may have a magnetic orientation that is normal to the first and second surfaces of the substrate 128. In one aspect, when the vicinity use card 100 is attached to the portable electronic device 102, the magnets 122 may have a north pole oriented in a direction facing towards the portable electronic device 102 a south pole oriented in a direction facing away from the portable electronic device 102. In another aspect, when the vicinity use card 100 is attached to the portable electronic device 102, the magnets 122 may have a north pole that is oriented in a direction facing away from the portable electronic device 102 and a south pole oriented in a direction facing towards the portable electronic device 102. As another example, rather than having multiple magnets 122, the magnet array 120 may be formed of a single, monolithic annular magnet 122.

FIG. 11A-11B illustrate various vicinity use cards 1100A, 1100B having multiple layers, according to several aspects of the present disclosure. Any aspects of the vicinity use cards 1100A, 1100B can be included in the vicinity use card 100 described above (and vice versa). As noted above with respect to FIG. 5, the vicinity use card 100 can be constructed using one or more than one layer of material. FIG. 11A illustrates one example of a vicinity use card 1100A including a layer 1110, a layer 1120, and a layer 1130. Each of the layers 1110, 1120, 1130 may be laminated or otherwise bonded together to form the card body 1102. FIG. 11B illustrates one example of a vicinity use card 1100B including a layer 1110, a layer 1120, a layer 1130, and a layer 1140. Each of the layers 1110, 1120, 1130, and 1140 may be laminated or otherwise bonded together to form the card body 1102. In other aspects, the vicinity use cards 1100A, 1100B can have less than 3 layers (e.g., one layer or two layers) or more than four layers (e.g., five layers, six layers, seven layers, etc.) that are laminated or otherwise bonded together to form the card body 1102.

Referring still to FIG. 11A and FIG. 11B, in some aspects, the layers 1110, 1130 may be printed layers. For example, the layer 1110 may define a first surface (e.g., front surface) of the vicinity use card 1100A, 1100B and can include a graphic and/or text that is printed, etched, embedded, or otherwise formed thereon. Likewise, the layer 1130 may define a second surface (e.g., back surface) that is opposite the first surface and can include a graphic and/or text that is printed, etched, embedded, or otherwise formed thereon.

Referring still to FIG. 11A and FIG. 11B, the layer 1120 may be a core layer. For example the layer 1120 may be configured to primarily provide structural support to the card body 1102. Thus, in some aspects, the layer 1120 may have a thickness that is relatively thicker than the layer 1110 and/or the layer 1130. Further, referring to FIGS. 7, 11A, and 11B, in some aspects, the integrated circuit 138, the wireless charging controller 134, the card charging coil 132, and/or the capacitor 136 may be embedded in, supported by, or otherwise included in the layer 1120.

Referring now to FIG. 11B, the layer 1140 may be an NFC antenna layer. For example an NFC antenna 1142 (e.g., the NFC antenna 150 of FIG. 7) may be embedded in, supported by, or otherwise included in the layer 1140. In some aspects, an integrated chip 1244 (e.g., the integrated circuit 138 of FIG. 7), a wireless charging controller 1146 (e.g., the wireless charging controller 134 of FIG. 7), a card charging coil 1148 (e.g., the card charging coil 132 of FIG. 7), and/or a capacitor 1150 (e.g., the capacitor 136 of FIG. 7) may be embedded in, supported by, or otherwise included in the layer 1140. In some aspects, the integrated chip 1244, the wireless charging controller 1146, the card charging coil 1148, and/or the capacitor 1150 may be embedded or otherwise included in one or more than one layer other than the layer 1140. For example, the integrated chip 1244, the wireless charging controller 1146, the card charging coil 1148, and/or the capacitor 1150 may be included in or otherwise be supported by the layer 1110, the layer 1120, and/or the layer 1130.

In some aspects, the vicinity use card 1100A, 1100B may include one or more than one transparent layer (not shown in FIGS. 11A-11B). For example, a transparent layer may be placed on an outer surface of the layer 1110 and/or an outer surface of the layer 1130. Thus, in some aspects, a first transparent layer may define a first surface (e.g., front surface) of the vicinity use card 1100A, 1100B (and/or the card body 1102) that protects a printed layer (e.g., the layer 1110) while still allowing any graphics or text included in the printed layer to be visible. Likewise, in some aspects, a second transparent layer may define a second surface (e.g., back surface) of the vicinity use card 1100A, 1100B (and/or the card body 1102) that protects a printed layer (e.g., the layer 1130) while still allowing any graphics or text included in the printed layer to be visible. The transparent layer(s) may include a transparent film made of, for example, polyvinyl chloride (PVC) or polyethylene terephthalate (PET). In some aspects, a magnetic stripe storing data (e.g., an account identifier, a name of an account holder, etc.) readable by an access device to initiate a transaction may be included on a transparent layer. In other aspects, a magnetic stripe storing data may be included on the layer 1110, the layer 1130, and/or another layer of the vicinity use card 1100A, 1100B.

Any of the layers of the vicinity use cards 1100A, 1100B may be constructed using a polymeric material, a metallic material, a paper material, and/or a wood material. Examples of suitable polymeric materials may include polyvinyl chloride (PVC), polyvinyl chloride acetate (PVCA), polylactic acid (PLA), acrylonitrile butadiene styrene (ABS), polyethylene terephthalate (PET), polyester, polycarbonate, polyethylene terephthalate (PET), polyethylene terephthalate glycol (PETG), polyolefin, polycarbonate, polyester, polyamide, and copolymers and/or blends of any thereof. Examples of suitable metallic materials may include stainless steel, aluminum, tungsten, gold, titanium, copper, and alloys of any thereof. Any of the layers of the vicinity use cards 1100A, 1100B may be bonded together using heat and/or an appropriate adhesive such as an epoxy-, polyurethane-, and/or acrylate-based adhesive.

Referring still to FIG. 11A and FIG. 11B, in various aspects, the mass of the card body 1102 can be in a range of 3 g to 25 g, such as about 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23 g, 24 g, or about 25 g. In various aspects, the thickness of the card body 1102 can be in a range of 0.50 mm to 1.00 mm, such as about 0.50 mm, 0.60 mm, 0.70 mm, 0.76 mm, 0.80 mm, 0.90 mm, or about 1.00 mm. In certain aspects, the mass and/or thickness of the card body 1102 can be the standard mass and/or thickness for a vicinity use card. For example, the card body 1102 can be configured with a thickness required for the vicinity use card 1100A, 1100B to be readily swiped or inserted into an access device without interference.

As mentioned above with respect to FIG. 5, the substrate 128 can refer to any layer that forms part of the body of the vicinity use card 100 (e.g., the card body) or the entire body of the vicinity use card 100. Thus, referring now to FIG. 5 and FIGS. 11A-11B, the substrate 118 can be any one or more than one of the layers 1110, 1120, 1130, 1140, such as, for example, all of the layers (e.g., the entire card body 1102). Any of the magnets (e.g., magnets 122, 1104, 1114, 1114, 1134, 1202) and alignment magnets (e.g., alignment magnets 116, 1202) disclosed herein can be embedded in any one or more than one of the layers 1110, 1120, 1130, 1140.

FIG. 12A-12C respectively illustrate cross-sectional views of magnet embedding configurations 1200A, 1200B, 1200C, according to several aspects of the present disclosure. Each magnet embedding configuration 1200A, 1200B, 1200C can include a magnet 1202 embedded in a substrate 1204. Each substrate 1204 can include a first surface 1210 and a second surface 1212 opposite the first surface 1210. Further, in each magnet embedding configuration 1200A, 1200B, 1200C, the magnet 1202 does not protrude beyond the first surface 1210 or the second surface 1212. In some aspects, the substrate 1204 shown in any of FIGS. 12A-12C can represent the substrate 128 referenced above with respect to FIG. 5, any one or more than one of the layers 1110, 1120, 1130, 1140 referenced above with respect to FIGS. 11A-11B, and/or the card body 1102 referenced above with respect to FIGS. 11A-11B. Thus, in some aspects, the substrate 1204 may be comprised of one or more than one layer. The magnet 1202 shown in any of FIGS. 12A-12C can represent any one of the magnets (e.g., magnets 122, 1004, 1014, 1024, 1034) and/or the alignment magnets (e.g., alignment magnets 126) disclosed herein.

Referring now to FIG. 12A, the magnet embedding configuration 1200A includes a magnet 1202 implanted into the substrate 1204 such that the magnet 1202 is substantially flush with the first surface 1210. In one aspect, the substrate 1204 of the magnet embedding configuration 1200A can represent a card body of a vicinity use card (e.g., the card body 1102 of FIGS. 11A and/or 11B) where any individual layers included in the card body are not shown in FIG. 12A. In this aspect, the first surface 1210 and the second surface 1212 of the substrate 1204 may represent outer surfaces of a vicinity use card. In another aspect, the substrate 1204 of the magnet embedding configuration 1200A can represent one layer of a vicinity use card (e.g., one of the layers 1110, 1120, 1130, 1140 of FIGS. 11A and/or 11B). Accordingly, the first surface 1210 and the second surface 1212 of the substrate 1204 may represent outer surfaces of a single layer of a vicinity use card. The magnet 1202 of the magnet embedding configuration 1200A may be implanted into the substrate 1204 by subtractively removing a portion of the substrate 1204 to create a cavity and depositing the magnet 1202 in the cavity. Subtractively removing the portion of the substrate 1204 to create the cavity can include at least one of drilling, milling, laser cutting, etching, or machining the portion of the substrate 1204.

Referring now to FIG. 12B, the magnet embedding configuration 1200B includes a magnet 1202 implanted into the substrate 1204 such that the magnet is completely embedded in the substrate 1204. Further, the substrate 1204 of the magnet embedding configuration 1200B includes a first layer 1206 and a second layer 1208. Each of the first layer 1206 and the second layer 1208 can represent one or more than one layer of a card body of a vicinity use card (e.g., one or more than one of the layers 1110, 1120, 1130, 1140 of the card body 1102 of FIGS. 11A and/or 11B). For example, referring to FIGS. 12B and 11B, the first layer 1206 may represent the layer 1120 of vicinity use card 1100B and the second layer 1208 may represent the layer 1140 of the vicinity use card 1100B. As another example, still referring to FIGS. 12B and 11B, the first layer 1206 may represent the layers 1110 and 1120 of vicinity use card 1100B and the second layer 1208 may represent the layers 1140 and 1130 of the vicinity use card 1100B such that the substrate 1204 represents the entire card body 1102 of vicinity use card 1100B. Referring again to FIG. 12B, the magnet 1202 of the magnet embedding configuration 1200B may be implanted into the substrate 1204 by subtractively removing a portion of the first layer 1206 to create a first cavity, subtractively removing a portion of the second layer 1208 to create a second cavity, depositing the magnet 1202 into at least one of the first cavity or the second cavity, and placing the first layer 1206 and the second layer 1208 together such that the magnet 1202 spans the first cavity and the second cavity. Subtractively removing the portion of the first layer 1206 to create the first cavity and/or subtractively removing the portion of the second layer 1208 to create the second cavity can include at least one of drilling, milling, laser cutting, etching, or machining the portion of the first layer 1206 and/or the portion of the second layer 1208.

Referring now to FIG. 12C, the magnet embedding configuration 1200C includes a magnet 1202 that is molded (e.g., co-molded, insert molded) into the substrate 1204. In one aspect, the substrate 1204 of the magnet embedding configuration 1200C can represent one layer of a vicinity use card (e.g., one of the layers 1110, 1120, 1130, 1140 of FIGS. 12A and/or 12B). Accordingly, the first surface 1210 and the second surface 1212 of substrate 1204 may represent outer surfaces of a single layer of a vicinity use card. In another aspect, the substrate 1204 of the magnet embedding configuration 1200C can represent a card body of a vicinity use card. The magnet 1202 of the magnet embedding configuration 1200C may be molded into the substrate 1204 by placing the magnet 1202 into a cavity of a mold and injecting substrate material into the mold and around the magnet 1202. In aspects where the substrate material is a polymer material (e.g., a thermoplastic material), molding the magnet 1202 can further include curing the substrate material to form the substrate 1204 (e.g., to form a layer of a vicinity use card, to form a card body of a vicinity use card). In aspects where the substrate material is a metallic material (e.g., a liquid metallic material, powdered metallic material), molding the magnet 1202 can further include hardening (e.g., cooling, sintering) the substrate material to form the substrate 1204 (e.g., to form a layer of a vicinity use card, to form a card body of a vicinity use card). In the magnet embedding configuration 1200C depicted in FIG. 12C, the magnet 1202 is fully embedded in the substrate 1204. In other aspects, the magnet 1202 of the magnet embedding configuration 1200C may be substantially flush with the first surface 1210 of the substrate 1204 (e.g., similar to the magnet 1202 of the magnet embedding configuration 1200A depicted in FIG. 12A).

FIG. 13 is a diagram of an example payment network environment 1300 in which the vicinity use card 100 may be used to conduct a transaction, according to at least one aspect of the present disclosure. As shown in FIG. 13, the payment network environment 1300 can include payment gateway system 1302, a POS device 1304, the portable electronic device 102, the vicinity use card 100, an issuer system 1308, a transaction service provider system 1310, an acquirer system 1312, and a communication network 1314. The payment gateway system 1302, the POS device 1304, the vicinity use card 100, the issuer system 1308, the transaction service provider system 1310, and/or the acquirer system 1312 may interconnect (e.g., establish a connection to communicate) via wired connections, wireless connections, or a combination of wired and wireless connections.

The payment gateway system 1302 may include one or more devices capable of receiving information from and/or transmitting information to a POS device 1304, the portable electronic device 102, the vicinity use card 100, the issuer system 1308, the transaction service provider system 1310, and/or the acquirer system 1312 via the communication network 1314. For example, the payment gateway system 1302 may include a computing device, such as a server (e.g., a transaction processing server), a group of servers, and/or other like devices.

The POS device 1304 may include one or more devices capable of receiving information from and/or transmitting information to the payment gateway system 1302, the portable electronic device 102, the vicinity use card 100, the issuer system 1308, the transaction service provider system 1310, and/or the acquirer system 1312 via the communication network 1314. For example, the POS device 1304 may include a computing device and/or other like devices. The POS device 1304 may also include a device capable of receiving information from vicinity use card 100 via a communication connection (e.g., an NFC communication connection, an RFID communication connection, a Bluetooth® communication connection, and/or the like) with vicinity use card 100, and/or the like, and/or transmitting information to vicinity use card 100 via the communication connection, and/or the like. In some non-limiting embodiments, the POS device 1304 may be a component of a merchant system associated with a merchant, as described herein. In some aspects, the POS device 1304 may include one or more devices, such as computers, computer systems, and/or peripheral devices capable of being used by a merchant to conduct a payment transaction with a user using the vicinity use card 100. For example, POS device 1304 may include a POS terminal.

The issuer system 1308 may include one or more devices capable of receiving information from and/or transmitting information to payment gateway system 1302, the POS device 1304, the portable electronic device 102, the vicinity use card 100, transaction service provider system 1310, and/or the acquirer system 1312 via the communication network 1314. For example, issuer system 1308 may include a computing device, such as a server, a group of servers, and/or other like devices. In various aspects, the issuer system 1308 may be associated with an issuer institution. For example, the issuer system 1308 may be associated with an issuer institution that issued a credit account, debit account, credit card account, debit card account, and/or the like to a user associated with the vicinity use card 100.

The transaction service provider system 1310 may include one or more devices capable of receiving information from and/or transmitting information to the payment gateway system 1302, the POS device 1304, the portable electronic device 102, the vicinity use card 100, the issuer system 1308, and/or the acquirer system 1312 via the communication network 1314. For example, the transaction service provider system 1310 may include a computing device, such as a server (e.g., a transaction processing server), a group of servers, and/or other like devices. In some aspects, the transaction service provider system 1310 may be associated with a transaction service provider. In some aspects, transaction service provider system 1310 may be in communication with a data storage device, which may be local or remote to the transaction service provider system 1310. In some aspects, the transaction service provider system 1310 may be capable of receiving information from, storing information in, transmitting information to, or searching information stored in a data storage device.

The acquirer system 1312 may include one or more devices capable of receiving information from and/or transmitting information to the payment gateway system 1302, the POS device 1304, the portable electronic device 102, the vicinity use card 100, the issuer system 1308, and/or the transaction service provider system 1310 via the communication network 1314. For example, the acquirer system 1312 may include a computing device, such as a server, a group of servers, and/or other like devices. In some aspects, acquirer system 1312 may be associated with an acquirer. In some aspects, the acquirer system 1312 may be associated with a merchant account of a merchant associated with the POS device 1304.

The communication network 1314 may include one or more wired and/or wireless networks. For example, the communication network 1314 may include a cellular network (e.g., a long-term evolution (LTE) network, a fourth generation (4G), a fifth generation (5G) network, network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 13 are provided as an example. There may be additional devices and/or networks, fewer devices and/or networks, different devices and/or networks, or differently arranged devices and/or networks than those shown in FIG. 13. Furthermore, two or more devices shown in FIG. 13 may be implemented within a single device, or a single device shown in FIG. 13 may be implemented as multiple, distributed devices. Additionally or alternatively, a set of devices (e.g., one or more devices) of the payment network environment 1300 may perform one or more functions described as being performed by another set of devices of the payment network environment 1300.

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.

Clause 1: A card removably attachable to a portable electronic device configured for reverse wireless charging and comprising a device charging coil, the card comprising: a card charging coil to produce a current from magnetic flux generated by the device charging coil; a capacitor electrically coupled to the card charging coil; and a circuit configured to: cause the capacitor to charge when the card is attached to the portable electronic device; and cause the capacitor to discharge upon removal of the card from the portable electronic device.

Clause 2: The card of Clause 1, wherein the circuit is further configured to: detect a discharge level of the capacitor; and implement a security action based on the discharge level reaching a discharge level threshold.

Clause 3: The card of Clause 2, wherein the security action comprises at least one of preventing a transaction using the card or requiring verification to complete a transaction using the card.

Clause 4: The card of any of Clauses 2-3, wherein the discharge level comprises a voltage across the capacitor.

Clause 5: The card of any of Clauses 2-4, wherein the capacitor fully discharges over a predetermined total discharge time.

Clause 6: The card of Clause 5, wherein the predetermined total discharge time is selected in a range of 30 seconds to 1,800 seconds, and wherein the discharge level threshold is based on a discharge time selected in a range of 15 seconds to 900 seconds.

Clause 7: The card of any of Clauses 5-6, wherein the predetermined total discharge time is 180 seconds, and wherein the discharge level threshold is based on a discharge time of 90 seconds.

Clause 8: The card of any of Clauses 2-7, wherein the circuit comprises: an Europay Mastercard Visa (EMV) chip to implement the security action.

Clause 9. The card of any of Clauses 1-8, wherein the portable electronic device further comprises a reverse wireless charging controller, and wherein the circuit comprises: a wireless charging circuit configured to wirelessly communicate with the reverse wireless charging controller.

Clause 10: The card of Clause 9, wherein the wireless charging circuit is configured to detect charge on the capacitor and communicate a signal to the reverse wireless charging controller to cause the portable electronic device to stop generating the magnetic flux from the device charging coil based on detecting the charge on the capacitor.

Clause 11: The card of any of Clauses 9-10, wherein the wireless charging circuit is configured to communicate to the reverse wireless charging controller an authentication certificate that is validated to authenticate the card, and wherein the portable electronic device is configured to generate the magnetic flux from the device charging coil only after the card is authenticated.

Clause 12: The card of any of Clauses 9-11, wherein the wireless charging circuit is configured to communicate to the reverse wireless charging controller an authentication certificate that is validated to authenticate the portable electronic device, and wherein the wireless charging circuit is configured to cause the capacitor to charge only after the portable electronic device is authenticated.

Clause 13: The card of any of Clauses 1-12, wherein the portable electronic device further comprises a ferromagnetic component disposed about the device charging coil and a ferromagnetic alignment component, and wherein the card further comprises: a magnet to magnetically couple to the ferromagnetic component disposed about the device charging coil to align the card charging coil and the device charging coil.

Clause 14: The card of Clause 13, wherein the card further comprises: an alignment magnet to magnetically couple to the ferromagnetic alignment component to align the card relative to the portable electronic device.

Clause 15: A payment card comprising: a substrate; an integrated circuit supported by the substrate, wherein the integrated circuit is configured to communicate with an access device to determine whether to complete a transaction; a card charging coil supported by the substrate, the card charging coil to produce a current from a magnetic flux generated by a wireless charging device; and a capacitor supported by the substrate and electrically coupled to the card charging coil, wherein the capacitor is chargeable with the current produced by the card charging coil.

Clause 16: The payment card of Clause 15, further comprising: a wireless charging circuit supported by the substrate and electrically coupled to the card charging coil, wherein the wireless charging circuit is configured to cause the wireless charging device to generate the magnetic flux.

Clause 17: The payment card Clause 16, wherein the wireless charging circuit is further comprises a near field communication (NFC) antenna, and wherein the wireless charging circuit is configured to communicate with the wireless charging device via the NFC antenna.

Clause 18: The payment card of any of Clauses 16-17, wherein the wireless charging circuit is communicatively coupled to the integrated circuit, wherein the wireless charging circuit is further configured to measure a voltage of the capacitor, and wherein the communication of the integrated circuit with the access device is based on the voltage of the capacitor.

Clause 19: The payment card of any of Clauses 15-18, further comprising: a magnet supported by the substrate, the magnet to magnetically couple the payment card to the wireless charging device.

Clause 20: The payment card of any of Clauses 15-19, wherein the wireless charging device is a portable electronic device.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A card removably attachable to a portable electronic device configured for reverse wireless charging and comprising a device charging coil, the card comprising:
a card charging coil to produce a current from magnetic flux generated by the device charging coil;
a capacitor electrically coupled to the card charging coil; and
a circuit configured to:
cause the capacitor to charge when the card is attached to the portable electronic device; and
cause the capacitor to discharge upon removal of the card from the portable electronic device.

2. The card of claim 1, wherein the circuit is further configured to:
detect a discharge level of the capacitor; and
implement a security action based on the discharge level reaching a discharge level threshold.

3. The card of claim 2, wherein the security action comprises at least one of preventing a transaction using the card or requiring verification to complete a transaction using the card.

4. The card of claim 2, wherein the discharge level comprises a voltage across the capacitor.

5. The card of claim 2, wherein the capacitor fully discharges over a predetermined total discharge time.

6. The card of claim 5, wherein the predetermined total discharge time is selected in a range of 30 seconds to 1,800 seconds, and wherein the discharge level threshold is based on a discharge time selected in a range of 15 seconds to 900 seconds.

7. The card of claim 6, wherein the predetermined total discharge time is 180 seconds, and wherein the discharge level threshold is based on a discharge time of 90 seconds.

8. The card of claim 2, wherein the circuit comprises:
an Europay Mastercard Visa (EMV) chip to implement the security action.

9. The card of claim 1, wherein the portable electronic device further comprises a reverse wireless charging controller, and wherein the circuit comprises:
a wireless charging circuit configured to wirelessly communicate with the reverse wireless charging controller.

10. The card of claim 9, wherein the wireless charging circuit is configured to detect charge on the capacitor and communicate a signal to the reverse wireless charging controller to cause the portable electronic device to stop generating the magnetic flux from the device charging coil based on detecting the charge on the capacitor.

11. The card of claim 9, wherein the wireless charging circuit is configured to communicate to the reverse wireless charging controller an authentication certificate that is validated to authenticate the card, and wherein the portable electronic device is configured to generate the magnetic flux from the device charging coil only after the card is authenticated.

12. The card of claim 9, wherein the wireless charging circuit is configured to communicate to the reverse wireless charging controller an authentication certificate that is validated to authenticate the portable electronic device, and wherein the wireless charging circuit is configured to cause the capacitor to charge only after the portable electronic device is authenticated.

13. The card of claim 1, wherein the portable electronic device further comprises a ferromagnetic component disposed about the device charging coil and a ferromagnetic alignment component, and wherein the card further comprises:
a magnet to magnetically couple to the ferromagnetic component disposed about the device charging coil to align the card charging coil and the device charging coil.

14. The card of claim 13, wherein the card further comprises:
an alignment magnet to magnetically couple to the ferromagnetic alignment component to align the card relative to the portable electronic device.

15. A payment card comprising:
a substrate;
an integrated circuit supported by the substrate, wherein the integrated circuit is configured to communicate with an access device to determine whether to complete a transaction;
a card charging coil supported by the substrate, the card charging coil to produce a current from a magnetic flux generated by a wireless charging device; and
a capacitor supported by the substrate and electrically coupled to the card charging coil, wherein the capacitor is chargeable with the current produced by the card charging coil.

16. The payment card of claim 15, further comprising:
a wireless charging circuit supported by the substrate and electrically coupled to the card charging coil, wherein the wireless charging circuit is configured to cause the wireless charging device to generate the magnetic flux.

17. The payment card of claim 16, wherein the wireless charging circuit is further comprises a near field communication (NFC) antenna, and wherein the wireless charging circuit is configured to communicate with the wireless charging device via the NFC antenna.

18. The payment card of claim 16, wherein the wireless charging circuit is communicatively coupled to the integrated circuit, wherein the wireless charging circuit is further configured to measure a voltage of the capacitor, and wherein the communication of the integrated circuit with the access device is based on the voltage of the capacitor.

19. The payment card of claim 15, further comprising:
a magnet supported by the substrate, the magnet to magnetically couple the payment card to the wireless charging device.

20. The payment card of claim 15, wherein the wireless charging device is a portable electronic device.
